(19) United States
(12) Patent Application Publication
(10) Pub. No.: US 2007/0236327 A1
(43) Pub. Date: Oct. 11, 2007

(54) Apparatus, method, program and system for remote control

(75) Inventors: Takeshi Miyashita, Asaka-shi (JP); Atsushi Misawa, Asaka-shi (JP); Kazushige Ooi, Kurokawa-gun (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/723,927

(22) Filed: Mar. 22, 2007

(30) Foreign Application Priority Data
Mar. 24, 2006 (JP) 2006-084029

(51) Int. Cl. G05B 23/02

(52) U.S. Cl. 340/3.71; 340/825.72; 340/825.22; 341/176

(57) ABSTRACT

According to a remote control apparatus of the present invention, an image and device-specific information acquired by the acquisition section are stored in a non-volatile storage medium being associated with each other. Subsequently, an image stored in the storage medium is displayed, a desired device is selected based on specific information stored in the storage medium, and desired remote control for the device is selected. Then, a remote control signal corresponding to the selected remote control is transmitted to the selected device.

### BACKGROUND OF THE INVENTION

1. Field of the Invention

The present invention relates to a technique for obtaining device-specific information with image pickup elements and remotely controlling a desired device based on the obtained device-specific information.

2. Description of the Related Art

There have been developed various techniques for easily controlling a desired device with a single controller from among a plurality of devices. For example, according to Japanese Patent Application Laid-Open No. 2003-284168, a physical topology map which describes physical position of a plurality of devices is prestored in memory of a remote control and a user operates a direction button on the remote control according to the actual position of the devices. A desired device is selected by the remote control referencing and tracing the physical topology map according to the user's input to the direction button. This enables the user to select a desired device promptly and intuitively. The remote control has a map creation section which automatically collects information on physical position of devices which is necessary for creating the physical topology map by utilizing characteristics of radio and/or a network.

According to Japanese Patent Application Laid-Open No. 2002-291072, a server apparatus is provided for storing remote control operation information corresponding to individual devices that can be controlled by a remote control. The portable remote control terminal has a transmission section for transmitting to the server apparatus remote control operation information requesting data for requesting remote control operation information corresponding to a selected device which is to be controlled by the remote control via a wireless communication device or a public communication line. Based on the remote control operation information requesting data, the server apparatus transmits remote control operation information corresponding to the selected device, which is to be operated by the remote control, to the portable remote control terminal.

According to a Non-patent Document, an ID is received from an information appliance while an ordinary image is captured in real time using a custom image sensor contained in a mobile phone. The received ID is indicated on a display overlapping a background image captured. The user can operate a device of interest while seeing it on the display (see “Proposal of ‘OPTO-NAVI’ System, which is an information-appliance multi-purpose remote controller using a low power consumption ID-receiving CMOS image sensor having a function of reading a partial area at a high speed” (The Journal of the Institute of Image Information and Television Engineers Vol. 59, No. 12, pp. 1830-1840 (2005))).

### SUMMARY OF THE INVENTION

The technique disclosed in Japanese Patent Application Laid-Open No. 2003-284168 requires collection of device position information and involves burdensome creation of a topology map. Japanese Patent Application Laid-Open No. 2002-291072 discloses no device that enables visually easy selection of a device to be controlled with a remote control. With the technique described in the Non-patent Document, a user cannot operate a device of interest unless the user has a mobile phone in front of the device.

The present invention has been made in view of such problems and has an object of enabling a user to remotely and visually simply select a device which the user wants to operate even if the user is not in front of the device and perform desired remote control to the selected device.

A remote control apparatus according to the present invention includes: an acquisition section which acquires, by an image pickup element, an image of a device as a subject which is to be remotely controlled and information specific to the device which is optically transmitted from the device; a storage section which is a non-volatile storage medium for storing the image of the device and the information specific to the device acquired by the acquisition section being associated with each other; a display section which displays an image stored in the storage section; an instruction acceptance section which accepts, from a user, instructions of selection of a desired device to be remotely controlled from among devices whose specific information is stored in the storage section being associated with the image and selection of desired control to the selected device; a communication section which transmits a remote control signal at least to the device; and a remote controlling section which controls the communication section to transmit a remote control signal corresponding to the control for the device which has been selected via the instruction acceptance section to the device which has been selected via the instruction acceptance section.

According to the present invention, an image and device-specific information acquired by the acquisition section are stored in a non-volatile storage medium being associated with each other. Subsequently, an image stored in the storage medium is displayed, a desired device is selected based on specific information stored in the storage medium, and desired remote control for the device is selected. Then, a remote control signal corresponding to the selected remote control is transmitted to the selected device.

Unlike conventional arts, the present invention does not require a user to take an image of a device in front of the device to acquire information specific to the device every time the user wants to control the device. Thus, the user can easily remotely control a desired device while seeing an image in a visually simple way regardless of whether the user is in front of the device or not as long as a path for transmitting a remote control signal to the device is secured.

Preferably, the acquisition section acquires an address of a device as the information specific to the device; the remote controlling section controls the communication section to transmit a signal for requesting transmission of information on the device to the address of the device; the communication section transmits a signal for requesting transmission of information on the device to the address of the device in accordance with control by the remote controlling section, and receives information on the device from the device; and the display section displays the information on the device received by the communication section in relation to an image.

Information on the device includes at least one of state of the device and type of the device.

When it is desired to receive static or dynamic information on a device such as the type or state of the device, the device may also transmit its address including it in specific information and the address is accessed to acquire information whenever it is necessary to remotely control the device.

Preferably, the acquisition section acquires an address of the device as information specific to the device; the remote controlling section controls the communication section to transmit a signal for requesting transmission of information on remote control of the device to the address of the device; and the communication section transmits a signal for requesting transmission of information on remote control of the device to the address of the device in accordance with control by the remote controlling section, and receives information on remote control of the device from the device.

The communication section is connected to a server via a network; the remote controlling section controls the communication section to transmit to the server a signal for requesting transmission of information on remote control of the device; and the communication section transmits to the server a signal for requesting transmission of information on remote control of the device in accordance with control by the remote controlling section, and receives information on remote control of the device from the server.

The acquisition section may acquire an address of the server as information specific to the device, and the remote controlling section may control the communication section to transmit a signal for requesting transmission of information on remote control of the device to the address of the server.

Information on remote control of a device includes at least one of type of the device, a program for the remote controlling section to control transmission of remote control signals for the device, and a remote controlling method for the device.

When it is desired to receive static or dynamic information on remote control of a device such as the type of the device, a control program, and/or a remote controlling method, the device may transmit its address or the address of a server which is managed by the dealer or manufacturer of the device including the address in its specific information, and the address is accessed to acquire the latest information whenever it is necessary to remotely control the device.

The apparatus may further include a voice guidance section which provides voice guidance on information about a device including the type of the device or guidance on remote operation of the device.

When only visual guidance does not suffice, it is convenient to auxiliarily use audio to give information on remote operation of a device.

Also, the instruction acceptance section may accept instruction by recognizing the user's speech.

This is convenient as the user can instruct remote control by voice when manual operation is inconvenient for the user.

A remote control method according to the present invention includes the steps of: acquiring, by an image pickup element, an image of a device as a subject which is to be remotely controlled and information specific to the device which is optically transmitted from the device; storing the acquired image of the device and the information specific to the device being associated with each other in a non-volatile storage medium; displaying an image stored in the storage medium; accepting from a user instructions of selection of a desired device to be remotely controlled from among devices whose specific information is stored in the storage medium being associated with the image and selection of desired control to the selected device; and transmitting a remote control signal corresponding to the selected control for the selected device to the selected device.

A program according to the present invention causes a computer to execute the steps of: acquiring, by an image pickup element, an image of a device as a subject which is to be remotely controlled and information specific to the device which is optically transmitted from the device; storing the acquired image of the device and the information specific to the device being associated with each other in a non-volatile storage medium; displaying an image stored in the storage medium; accepting from a user instructions of selection of a desired device to be remotely controlled from among devices whose specific information is stored in the storage medium being associated with the image and selection of desired control to the selected device; and transmitting a remote control signal corresponding to the selected control for the selected device to the selected device.

A remote control system according to the present invention includes: a device which optically transmits specific information; an acquisition section which acquires, by an image pickup element, an image of a device as a subject which is to be remotely controlled and information specific to the device which is optically transmitted from the device; a storage section which is a non-volatile storage medium for storing the image of the device and the information specific to the device acquired by the acquisition section being associated with each other; a display section which displays an image stored in the storage section; an instruction acceptance section which accepts, from a user, instructions of selection of a desired device to be remotely controlled from among devices whose specific information is stored in the storage section being associated with the image and selection of desired control to the selected device; a communication section which transmits a remote control signal at least to the device; and a remote controlling section which controls the communication section to transmit a remote control signal corresponding to the control for the device which has been selected via the instruction acceptance section to the device which has been selected via the instruction acceptance section, wherein the device receives the remote control signal transmitted by the communication section and operates in accordance with control corresponding to the remote control signal received.

According to the invention, an image and device-specific information acquired by the acquisition section are stored in a non-volatile storage medium being associated with each other. Subsequently, an image stored in the storage medium is displayed, a desired device is selected based on specific information stored in the storage medium and desired remote control for the device is selected. Then, a remote control signal corresponding to the selected remote control is transmitted to the selected device.

Unlike conventional arts, the present invention does not require a user to acquire information specific to a device in front of the device every time the user wants to control the device. Thus, the user can easily remotely control a desired device while seeing an image in a visually simple way regardless of whether the user is in front of the device or not as long as a path for transmitting a remote control signal to the device is secured.

### BRIEF DESCRIPTION OF THE DRAWINGS

FIG. 1 illustrates the configuration of a remote control system according to a first embodiment;

FIG. 2 illustrates the configuration of an image storage apparatus;

FIG. 3 shows a flowchart illustrating the flow of an operation image acquisition process in the first embodiment;

FIG. 4 shows a flowchart illustrating the flow of a remote operation process in the first embodiment;

FIG. 5 illustrates the configuration of a remote control system according to a second embodiment;

FIG. 6 shows a flowchart illustrating the flow of an operation image acquisition process in the second embodiment;

FIG. 7 illustrates the configuration of a remote control system according to a third embodiment;

FIG. 8 illustrates the configuration of a remote control system in which a server's address is transmitted from a device according to the third embodiment;

FIG. 9 shows a flowchart illustrating the flow of a remote operation process according to a fourth embodiment;

FIG. 10 shows a flowchart illustrating the flow of an operation image acquisition process according to a fifth embodiment; and

FIG. 11 shows a flowchart illustrating the flow of a remote operation process according to the fifth embodiment.

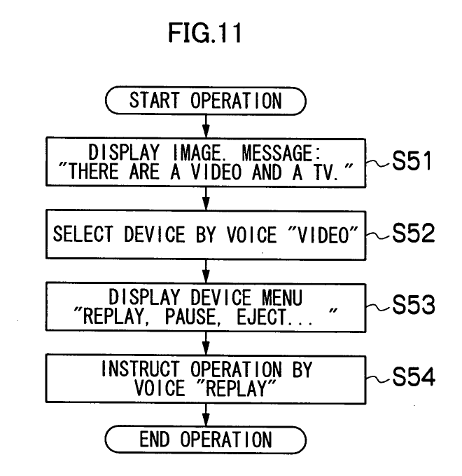

### DETAILED DESCRIPTION OF THE PREFERRED EMBODIMENTS

### First Embodiment

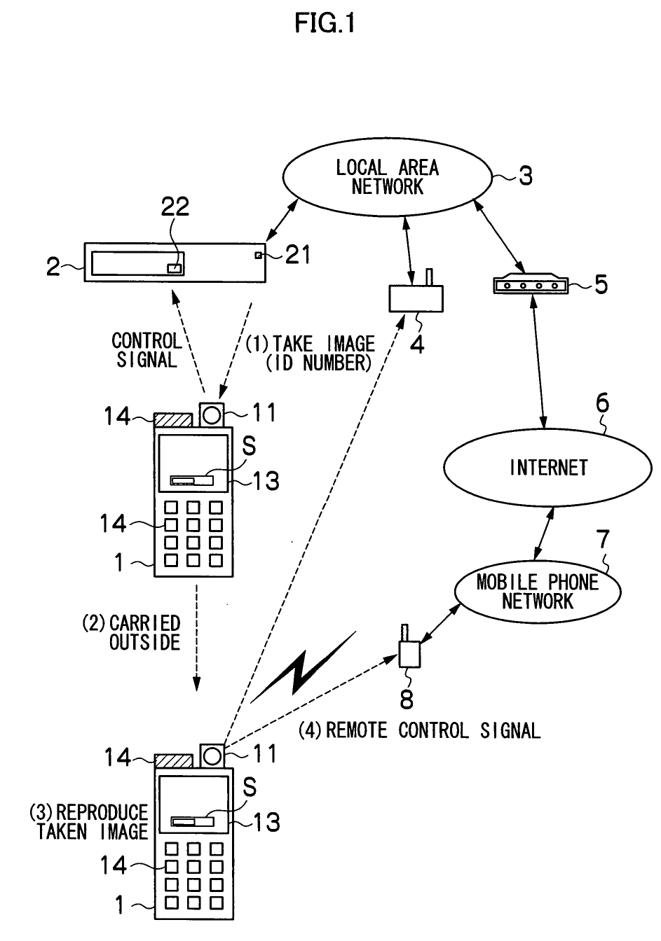

FIG. 1 generally illustrates the configuration of a remote control system according to a first preferred embodiment of the invention. The system includes an image storage apparatus 1 and a device 2 of any of various types which is controlled by the image storage apparatus 1, such as an AV device, personal computer, and cooking device. The image storage apparatus 1 connects to a LAN 3 through an external network via a base station 8, a mobile communication network 7, the Internet 6 and a router 5, or over wireless communication with a wireless station 4.

The device 2 is connected to the Internet 6 via the LAN 3 and the router 5, and the image storage apparatus 1 can be connected to the device 2 over an external network or wireless communication.

The device 2 has a specific information transmission section 21 which transmits device-specific information which is information specific to the device (any kind of information specific to the device 2, such as its identification number, ID, serial number, manufacturer number, model number, model, and address on an external network) by superimposing it on an optical signal such as an infrared signal, and a reception section 22 which receives a remote control signal from the image storage apparatus 1 (which is transmitted as an infrared signal or other optical signal, or Bluetooth or other electrical signal). The specific information transmission section 21 may be a light emitting diode, an infrared LED or the like.

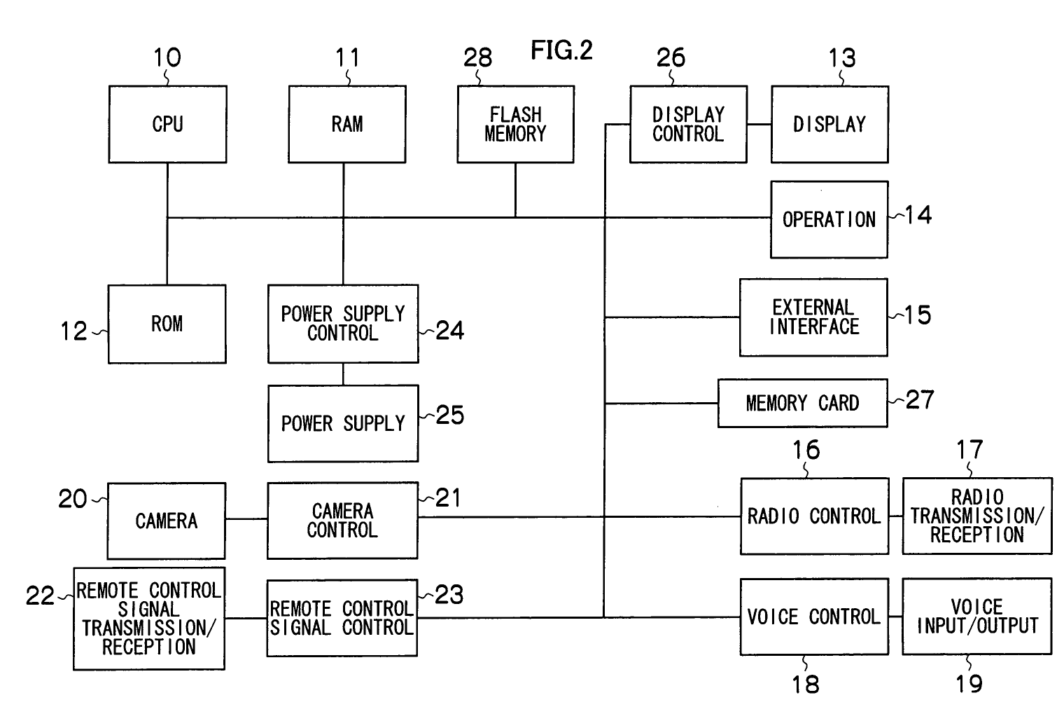

FIG. 2 shows a functional block diagram of the image storage apparatus 1 according to a preferred embodiment of the invention. The image storage apparatus 1 includes a camera section 20 which includes a taking lens, a solid-state image sensor such as CMOS and CCD, an analog front-end IC for processing analog images read by a driver from the solid-state image sensor into a digital signal, a signal processing IC such as a Digital Signal Processor (DSP) for processing digital image signals from the analog front-end IC, etc., and a camera control section 21, which may be a one-chip microcomputer and the like, for controlling image-taking operations of the camera section 20.

The image storage apparatus 1 also has a display control section 26 which controls display on a display section 13 in accordance with input operations to an operation section 14 which may be a numeric keypad, a cross key or the like, various operation signals received from outside by the remote control signal transmission/reception section 22, and/or images or device-specific information obtained by the camera section 20.

The image storage apparatus 1 also has a CPU 10 which is responsible for control of operation of the respective sections, a ROM 12 which stores various data and/or programs, and a RAM 11 which stores various data necessary for processing at the CPU 10.

The ROM 12 stores, among others, for each of devices 2 a control program for the CPU 10 to control a remote control signal control section 23 or a radio control section 16 to transmit a remote control signal on which a control code for the device 2 corresponding to an operation to the operation section 14 is superimposed, and a remote control GUI for visually indicating relationship between manipulation of a part of the operation section 14 and a control code which is superimposed in response to the manipulation.

For example, an optical double zoom lens is used as the image-taking lens, and the optical zoom magnification is changed by a motor driver forward and backward driving the image-taking lens to the telephotographic (tele) side or the wide-angle (wide) side in accordance with a magnification change operation inputted from the operation section 14. The magnification of the image-taking lens is not limited to the above. An aperture is provided for the image-taking lens. An appropriate amount of exposure is obtained by controlling the aperture via the motor driver.

When the photographing mode is set by the operation section 14, the CPU 10 displays a motion picture (live images) on the display section 13 to enable confirmation of the image-taking angle of field. That is, the solid-state image sensor converts a light of a subject which is incident through the image-taking lens and is formed on the light-receiving surface of the image sensor to an amount of signal charge corresponding to the amount of the light. The signal charges of respective pixels accumulated in this way are sequentially and individually read by the driver as voltage signals (image signals) corresponding to the signal charges, based on a driving pulse given by a timing generator in accordance with a direction from the CPU 10 and converted to digital signals in the analog front-end circuit, and each of them is added to the signal processing circuit.

The signal processing circuit includes a gain adjustment circuit and an A/D converter. It is an image processing device which includes a brightness/color difference signal generation circuit, a gamma correction circuit, a sharpness correction circuit, a contrast correction circuit, a white balance correction circuit, an outline processing section for performing imaging processing including outline correction for a taken image, a noise reduction processing section for performing noise reduction processing of an image and the like, and it processes an image signal in accordance with a command from the CPU 10.

The image data inputted into the signal processing circuit is converted to a brightness signal (Y signal) and a color difference signal (Cr/Cb signal), and the signals are stored in the VRAM after predetermined processings such as gamma correction is performed therefor.

When the monitor output of a taken image to the display section 13 is performed, a Y/C signal is read from the VRAM and sent to a display control section 26. The display control section 26 converts the inputted Y/C signal to a signal of a predetermined method for display (for example, a compound color picture signal of an NTSC method) and outputs it to the display section 13.

The Y/C signals of respective frames which have been processed at a predetermined frame rate are written in an A area and a B area of the VRAM alternatively, and a written Y/C signal is read not from the area in which a Y/C signal is being written but from the other area, between the A and B areas. By the Y/C signals in the VRAM being periodically overwritten, and picture signals generated from the Y/C signals being provided for the display section 13, the picture being taken is displayed on the display section 13 in real time. The user can confirm the image-taking angle of field by the picture (live images) displayed on the display section 13.

Here, when a photographing key provided on the operation section 14 is pressed, a photographing operation for storage is started. Image data acquired in response to the pressing of the photographing key is converted to a brightness/color difference signal (Y/C signal) in the signal processing circuit, and it is stored in the RAM 11 after predetermined processings such as gamma correction are performed therefor.

The Y/C signal stored in the RAM 11 is compressed in accordance with a predetermined format by a compression/expansion processing circuit and then stored in a memory card 27 as an image file in a predetermined format such as an Exif file. The image file can also be stored in a flash memory 28.

When the reproduction mode is set by the operation section 14, the compressed data of the final image file stored in the flash memory 28 (a file stored last) is read. When the file stored last is a still image file, the read compressed image data is expanded to an uncompressed Y/C signal via the compression/expansion processing circuit and stored in the VRAM. The Y/C signal stored in the VRAM is added to the display control section 26. The display control section 26 creates a compound RGB color picture signal of the NTSC method from the inputted Y/C signal and outputs it to the display section 13. Thereby, the frame image of the last frame stored in the memory card 27 is displayed on the display section 13.

After that, when the right key of a cross key provided on the operation section 14 is pressed, frame advancing is performed in the forward direction, and when the left key of the cross key is pressed, frame returning is performed in the opposite direction. Then, an image file at the frame position set by the frame advancing or returning is read from the memory card 27, and a frame image is reproduced on the display section 13 similarly as described above. If frame advancing is performed in the forward direction when the frame image of the last frame is displayed, the image file of the first frame stored in the memory card 27 is read, and the frame image of the first frame is reproduced on the display section 13.

The number of pixels of an image file to be stored is, for example, any of 2832×2128(6 M), 2048×1536 (3 M), 1280×960 (1 M) and 640×480 (VGA), and the amount of data of a taken image (the file size) changes according to the combination of the stored image quality and the number of stored pixels.

The remote control transmission/reception section 22 has a light-receiving element. Although FIG. 2 illustrates the camera section 20 and the remote control transmission/reception section 22 as separate components, the light-receiving element is actually combined with the solid-state image sensor of the camera section 20. Accordingly, when the camera section 20 takes an image of the specific information transmission section 21 of the device 2 as subject S, device-specific information optically transmitted by the device 2 can be obtained along with the image.

The remote control signal control section 23 converts device-specific information superimposed on an optical signal which is incident on the remote control transmission/reception section 22 from the external device 2 into digital data and outputs it to the CPU 10.

The CPU 10 retrieves a table defining control codes specific for the device 2 which is identified by the device-specific information from the ROM 12 into the RAM 11 in accordance with the device-specific information input from the remote control signal control section 23. Then, the CPU 10 retrieves a control code for the particular device 2 corresponding to an operation on the operation section 14 from the RAM 11 and sends the code to the remote control signal control section 23.

The remote control transmission/reception section 22 has an optical signal transmission device, which may be a light emitting diode, an infrared LED or the like. The remote control signal control section 23 transmits an optical signal on which a control code designated by the CPU 10 and other data are superimposed to the device 2. In this manner, a particular device 2 can be remotely operated through the operation section 14 by transmitting an optical control signal from the image storage apparatus 1 to the device 2.

The image storage apparatus 1 also has a radio transmission/reception section 17 which transmits/receives radio signals such as mobile communication radio wave, IrDA, Bluetooth, wireless LAN, Wireless USB to/from the base station 8 or the wireless station 4, a radio control section 16 which converts a received radio signal into data and sends it to the CPU 10 and/or superimposes a remote control signal designated by the CPU 10 onto a radio signal, and an external interface section 15 which communicates with various consumer electronics such as personal computers and printers in conformity with USB or other standards.

The CPU 10 can retrieve a control code for a particular device 2 corresponding to an operation on the operation section 14 from the RAM 11 and send it also to the radio control section 16. The radio control section 16 transmits a radio signal on which the control code input from the CPU 10 and other data are superimposed to the device 2. The radio signal is received by the wireless station 4 or the base station 8 to reach the device 2 via the LAN 3 or an external network. Upon receiving the control code, the device 2 performs an operation corresponding to the control code. In this manner, a particular device 2 can also be remotely operated through the operation section 14 by transmitting a radio signal from the image storage apparatus 1 to the device 2.

The image storage apparatus 1 has a voice input/output section 19 that includes a sounding device which makes a sound, e.g., a speaker, and a voice receiving device which receives sound and converts it to an electrical signal, e.g., a microphone, and a voice control section 18 which controls what is sounded from the sounding device.

The CPU 10 can also retrieve a control code for a particular device 2 corresponding to sound received by the voice input/output section 19 from the RAM 11 and send it to the remote control signal control section 23 or the radio control section 16. That is, a control code which will be transmitted as an optical signal or radio signal to a particular device 2 can also be designated through voice input, in addition to input operation to the operation section 14.

The CPU 10 also determines whether a control code should be transmitted from the remote control signal transmission/reception section 22 or the radio transmission/reception section 17 in accordance with an input operation to the operation section 14 or speech to the voice input/output section 19. When the image storage apparatus 1 is in front of the device 2 which is to be controlled, a control code may be transmitted from the remote control signal transmission/reception section 22. However, if this is not the case, the user instructs the CPU 10 to transmit a control code from the radio transmission/reception section 17 through an input operation to the operation section 14 and/or speech to the voice input/output section 19. The CPU 10 performs control so that the radio transmission/reception section 17 transmits the control code in accordance with the instruction.

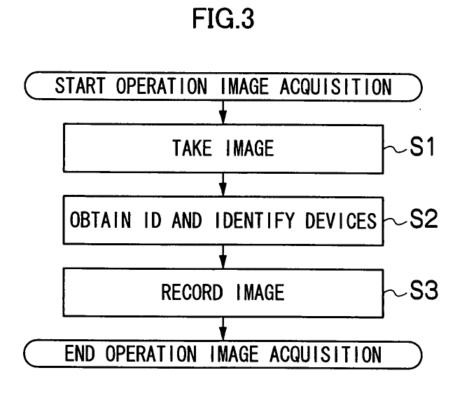

FIG. 3 shows a flowchart illustrating the flow of an operation image acquisition process by the image storage apparatus 1.

First, at S1, the CPU 10 instructs the camera control section 21 to start operation of still image acquisition in accordance an image-taking instruction input to the operation section 14. The camera control section 21 controls the camera section 20 to obtain a still image and device-specific information. The still image is once stored in the RAM 11.

At S2, the CPU 10 identifies the image obtained by the camera section 20 and devices 2 contained in the image as subjects based on the device-specific information.

At S3, the CPU 10 stores the image and device-specific information obtained by the camera section 20 and identified devices 2 by associating them with one another in a non-volatile storage medium such as a memory card 27 and a flash memory 28. One or more still images may be stored.

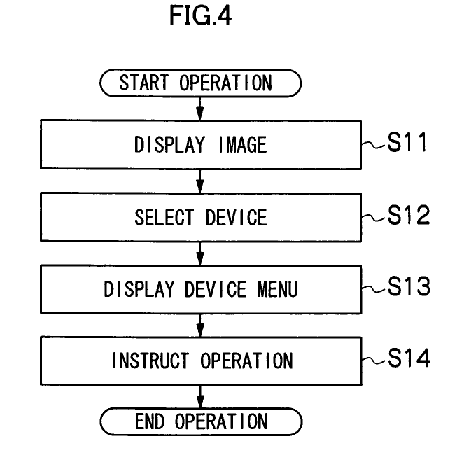

FIG. 4 shows a flowchart illustrating the flow of a remote operation process by the image storage apparatus 1.

At S11, the CPU 10 instructs the display control section 26 to retrieve a still image stored in the non-volatile storage medium into the RAM 11 through an operation image acquisition process and display it on the display section 13. If there are a plurality of still images, a desired one of them is selected through manual input to the operation section 14 or speech input to the voice input/output section 19 and the selected still image is displayed.

At S12, the CPU 10 prompts the user with indication on the display section 13 or voice guidance from the voice input/output section 19 to select a device 2 which the user wants to remotely control from among devices 2 stored in the non-volatile storage medium corresponding to the image by performing manual input to the operation section 14 or speech input to the voice input/output section 19. The CPU 10 selects a device 2 according to the user's manual input to the operation section 14 or speech input to the voice input/output section 19.

At S13, the CPU 10 retrieves a control program for the selected device 2 from the ROM 12 to the RAM 11 and executes it. In accordance with instructions from the control program, the CPU 10 retrieves a GUI corresponding to the selected device 2 from the ROM 12 to the RAM 11 and instructs the display control section 26 to display the GUI on the display section 13. The GUI may be displayed overlapping on an image.

At S14, the CPU 10 instructs the remote control signal control section 23 to transmit a control code prescribing a desired control operation from the remote control signal transmission/reception section 22, the radio transmission/reception section 17, or the external interface section 15 to the selected device 2 in accordance with manual input to the operation section 14 or speech input to the voice input/output section 19.

In this manner, the image storage apparatus 1 obtains a still image of the device 2 as a subject and device-specific information transmitted from the device 2 through image-taking operations of the camera section 20. The still image obtained and devices 2 identified by the device-specific information are stored being associated with each other. Then, the image storage apparatus 1 displays the stored still image and prompts the user to select a desired one from devices 2 corresponding to the still image and transmits a desired control code to the selected device 2 to remotely control the device 2.

Remote operation of a desired device 2 from any position can be realized by sending a desired control code from the radio transmission/reception section 17 to the device 2 based on an image and device-specific information which are previously stored, instead of the image storage apparatus 1 obtaining device-specific information from the device 2 in front of the device 2.

### Second Embodiment

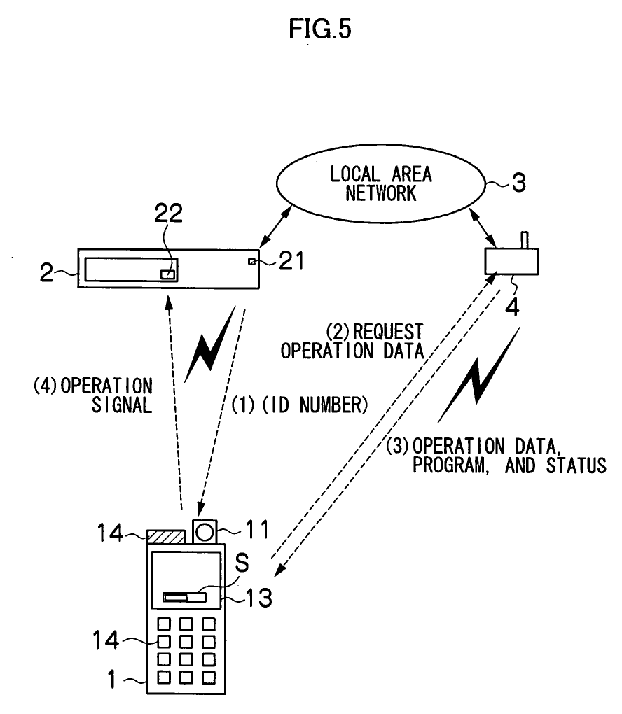

FIG. 5 generally shows the configuration of a remote control system according to a second preferred embodiment of the invention. The system includes an image storage apparatus 1 and a device 2. In this system, the image storage apparatus 1 connects to a LAN 3 through wireless communication with a wireless station 4. As other configurations are similar to the first embodiment, detailed descriptions of them are omitted.

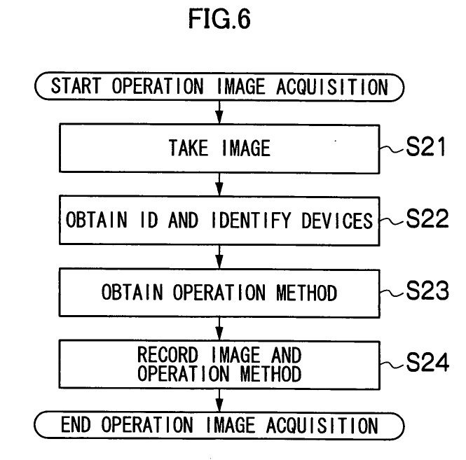

FIG. 6 shows a flowchart illustrating the flow of an operation image acquisition process by the image storage apparatus 1.

First, at S21, the CPU 10 instructs the camera control section 21 to start a still image acquisition operation in accordance with an image-taking instruction inputted to the operation section 14. The camera control section 21 controls the camera section 20 to obtain a still image and device-specific information.

At S22, the CPU 10 identifies devices 2 contained in the still image as subjects based on the image and device-specific information obtained by the camera section 20. The device-specific information contains the address of the devices 2 on the LAN 3.

At S23, the CPU 10 requests, for the address of each of the devices 2, information on control of the device 2, such as its status, a control code table, a control program, a GUI, a program and/or a document describing how to operate the device 2, and receives information transmitted in response to the request.

At S24, the CPU 10 stores the image and device-specific information obtained by the camera section 20, and information on control of the devices 2 in a non-volatile storage medium associating them with one another.

In this manner, remote control of the device 2 is further facilitated by obtaining information on control of the device 2 via the LAN 3 after acquisition of an image and device-specific information, storing the control information together with the image, and utilizing the information when the device 2 is actually operated.

### Third Embodiment

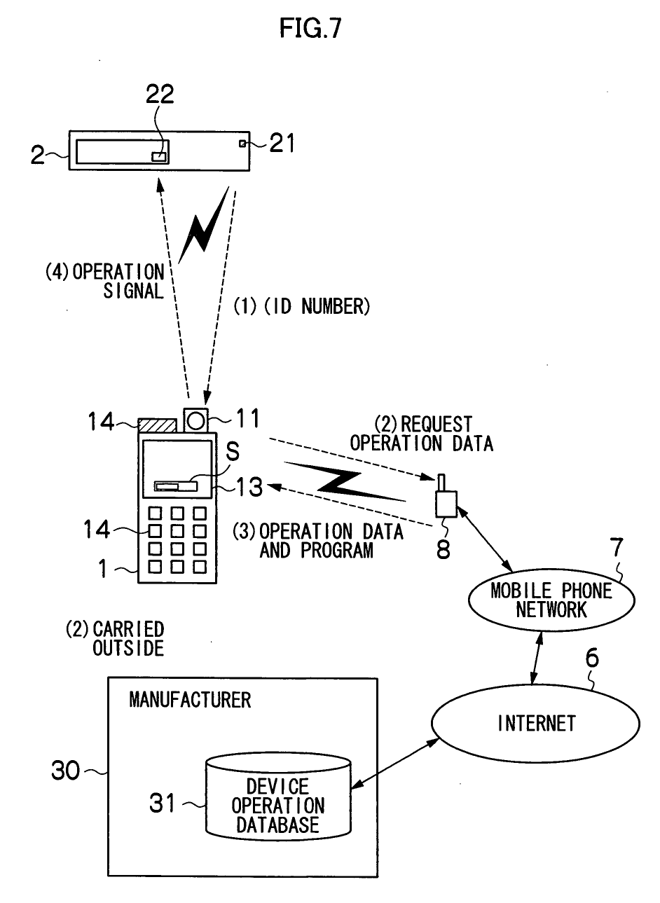

FIG. 7 generally illustrates the configuration of a remote control system according to a third preferred embodiment of the invention. The system includes an image storage apparatus 1, a device 2, and a server 30 of a manufacturer of the device 2. The image storage apparatus 1 connects to the server 30 over the Internet 6. As other configurations are similar to the first embodiment, their depiction and description are omitted.

The image storage apparatus 1 performs an operation image acquisition process which is similar to that in the second embodiment. However, at S23, the image storage apparatus 1 requests information on control of the device 2 for the server 30, not the device 2, and in response to the request, the server 30 extracts information on control of the device 2 from a device operation database 31 and sends it to the image storage apparatus 1. The image storage apparatus 1 receives the information on control of the device 2 from the server 30 and stores it in a non-volatile storage medium associating it with an image and device-specific information.

This eliminates the necessity for the device 2 to maintain information on its control by itself and enables the server 30 to send the latest information.

The address of the server 30 may be prestored in the ROM 12 of the image storage apparatus 1 or transmitted to the image storage apparatus 1 being included in device-specific information transmitted by the specific information transmission section 21 of the device 2.

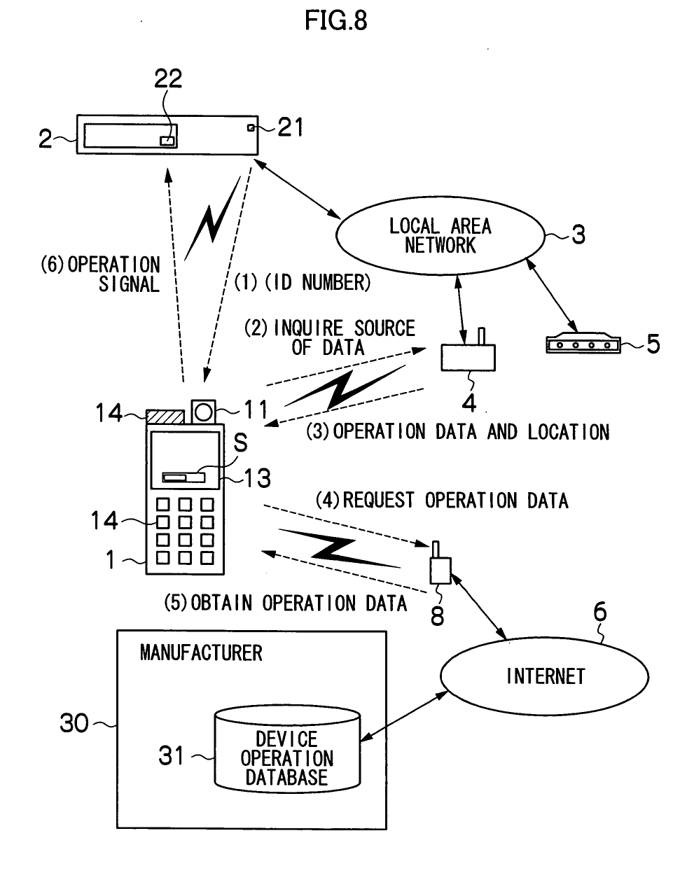

FIG. 8 shows a data flow for a case the address of the server 30 is transmitted from the device 2.

At S23, the specific information transmission section 21 of the device 2 transmits the address of the server 30 including it in device-specific information. The image storage apparatus 1 recognizes the address of the server 30 from the device-specific information. Alternatively, even if only the address of the device 2 is included in device-specific information, the image storage apparatus 1 may request the device 2 over the LAN 3 to send the address of the server 30 to have the device 2 transmit the address of the server 30 over the LAN 3. The image storage apparatus 1 accesses the address of the server 30 transmitted from the device 2 and requests information on control of the device 2. In response to the request, the server 30 sends information on control of the device 2 to the image storage apparatus 1. The image storage apparatus 1 receives the information on control of the device 2 from the server 30.

This enables the image storage apparatus 1 to access the server 30 of a corresponding manufacturer for any device 2 to obtain the latest information on the device 2 as long as the device 2 can send the address of the server 30.

### Fourth Embodiment

In a remote operation process of the first embodiment, the user can also designate by voice a device 2 which the user wants to operate.

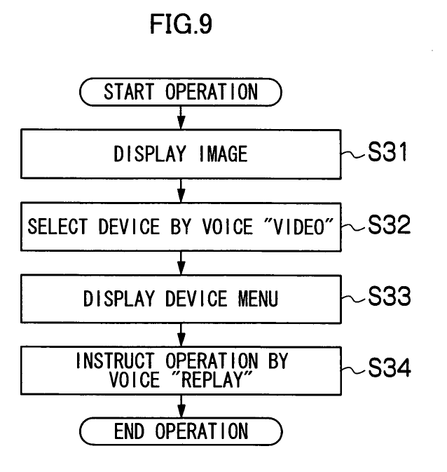

FIG. 9 shows a flowchart illustrating a remote operation process according to a fourth preferred embodiment of the invention.

At S31, the CPU 10 instructs the display control section 26 to display a still image stored in a non-volatile storage medium on the display section 13 through an operation image acquisition process. If there are a plurality of still images, the user is prompted to select a desired one of them through speech input to the voice input/output section 19 and the selected still image is displayed.

At S32, in accordance with an instruction to select a device 2 which is given through speech input to the voice input/output section 19 (e.g., an utterance specifying a device type such as “Video”), the CPU 10 selects a device 2 which the user wants to remotely operate from among devices 2 corresponding to the image.

At S33, the CPU 10 retrieves a GUI corresponding to the selected device 2 from the ROM 12 to the RAM 11 and instructs the display control section 26 to display the GUI on the display section 13.

At S34, the CPU 10 transmits a control code to the selected device 2 from the remote control signal transmission/reception section 22, the radio transmission/reception section 17, or the external interface section 15 in accordance with the contents of speech input to the voice input/output section 19 which is recognized by the voice control section 18. For example, if an utterance “Replay” is input to the voice input/output section 19 and the voice control section 18 correspondingly recognizes a word “replay”, the CPU 10 instructs the remote control signal control section 23 and the like to transmit a control code for starting reproduction of an image to a device 2 which is a “video cassette recorder”.

In addition, request for information on control of the device 2 from the server 30 of the third embodiment may also be done based on speech input to the voice input/output section 19.

### Fifth Embodiment

In an operation image acquisition process of the first embodiment, it is also possible to audibly inform acquisition of an image, the type of a device 2 which is identified by device-specific information, an operation procedure, and an operation result.

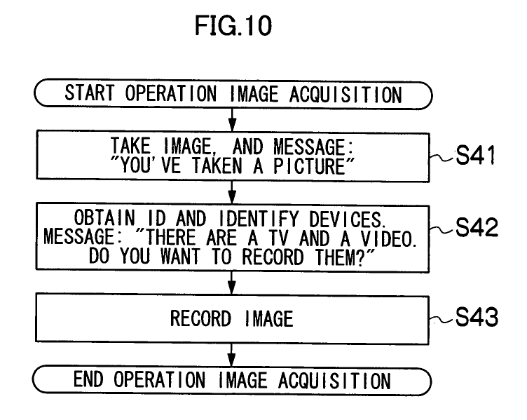

FIG. 10 shows a flowchart illustrating the flow of an operation image acquisition process according to a fifth preferred embodiment of the invention.

At S41, the CPU 10 instructs the camera control section 21 to start acquisition of a still image in accordance with an image-taking instruction input to the operation section 14 or the voice input/output section 19. The camera control section 21 controls the camera section 20 to obtain a still image and device-specific information. The still image and device-specific information are once stored in the RAM 11. When storage of the image completes, the CPU 10 instructs the voice control section 18 to sound a guidance message informing completion of storage of the image, e.g., “You've taken a picture”, from the voice input/output section 19.

At S42, the CPU 10 identifies devices 2 based on the device-specific information in the RAM 11. When identification of devices 2 is complete, the CPU 10 instructs the voice control section 18 to sound a guidance message for informing the type of the identified devices 2 and confirming whether the image should be stored or not, e.g., “There are a television and a VCR. Do you want to store them?”, from the voice input/output section 19.

At S43, in accordance with an instruction to store the image which is input to the operation section 14 or the voice input/output section 19, the CPU 10 stores the image and device-specific information for the devices 2 obtained by the camera section 20 in a non-volatile storage medium associating them with each other.

Further, in a remote operation process, processing is done in a flow described below when the user designates by voice a device 2 which the user wants to remotely operate.

At S51, the CPU 10 instructs the display control section 26 to display a still image stored in a non-volatile storage medium on the display section 13 through an operation image acquisition process. In this process, the CPU 10 instructs the voice control section 18 to sound a guidance message informing the type of devices 2 which are identified by device-specific information in the non-volatile storage medium, e.g., “There are a television and a video”, from the voice input/output section 19.

At S52, the CPU 10 selects a device 2 which the user wants to remotely operate in accordance with an instruction to select a device 2 which is given through speech input to the voice input/output section 19 (e.g., an utterance designating a device type, such as “Video”.)

At S53, the CPU 10 retrieves a GUI corresponding to the selected device 2 (e.g., a selection menu for selecting Replay, Pause, or Eject, which are remote control codes for a “video”) from the ROM 12 into the RAM 11 and instructs the display control section 26 to display the GUI on the display section 13.

At S54, the CPU 10 instructs the remote control signal control section 23 to transmit a control code to the selected device 2 in accordance with speech input to the voice input/output section 19 from the remote control signal transmission/reception section 22, the radio transmission/reception section 17, or the external interface section 15. For example, when an utterance “Replay” is input to the voice input/output section 19, the CPU 10 instructs the remote control signal control section 23 and the like to transmit a control code for starting reproduction of an image to a device 2 which is a “video cassette recorder”.

As described above, voice guidance or voice instruction for remote control may also be enabled.

What is claimed is:

1. A remote control apparatus, comprising:
an acquisition section which acquires, by an image pickup element, an image of a device as a subject which is to be remotely controlled and information specific to the device which is optically transmitted from the device;
a storage section which is a non-volatile storage medium for storing the image of the device and the information specific to the device acquired by the acquisition section being associated with each other;
a display section which displays an image stored in the storage section;
an instruction acceptance section which accepts, from a user, instructions of selection of a desired device to be remotely controlled from among devices whose specific information is stored in the storage section being associated with the image and selection of desired control to the selected device;
a communication section which transmits a remote control signal at least to the device; and
a remote controlling section which controls the communication section to transmit a remote control signal corresponding to the control for the device which has been selected via the instruction acceptance section to the device which has been selected via the instruction acceptance section.

2. The remote control apparatus according to claim 1, wherein
the acquisition section acquires an address of the device as the information specific to the device;
the remote controlling section controls the communication section to transmit a signal for requesting transmission of information on the device to the address of the device;
the communication section transmits a signal for requesting transmission of information on the device to the address of the device in accordance with control by the remote controlling section, and receives information on the device from the device; and
the display section displays the information on the device received by the communication section in relation to the image.

3. The remote control apparatus according to claim 2, wherein the information on the device includes at least one of state of the device and type of the device.

4. The remote control apparatus according to claim 1, wherein
the acquisition section acquires an address of the device as information specific to the device;
the remote controlling section controls the communication section to transmit a signal for requesting transmission of information on remote control of the device to the address of the device; and
the communication section transmits a signal for requesting transmission of information on remote control of the device to the address of the device in accordance with control by the remote controlling section, and receives information on remote control of the device from the device.

5. The remote control apparatus according to claim 1, wherein
the communication section is connected to a server via a network;
the remote controlling section controls the communication section to transmit to the server a signal for requesting transmission of information on remote control of the device; and
the communication section transmits to the server a signal for requesting transmission of information on remote control of the device in accordance with control by the remote controlling section, and receives information on remote control of the device from the server.

6. The remote control apparatus according to claim 5, wherein
the acquisition section acquires an address of the server as information specific to the device, and
the remote controlling section controls the communication section to transmit a signal for requesting transmission of information on remote control of the device to the address of the server.

7. The remote control apparatus according to claim 5, wherein the information on remote control of the device includes at least one of type of the device, a program for the remote controlling section to control transmission of remote control signals for the device, and a remote controlling method for the device.

8. The remote control apparatus according to claim 6, wherein the information on remote control of the device includes at least one of type of the device, a program for the remote controlling section to control transmission of remote control signals for the device, and a remote controlling method for the device.

9. The remote control apparatus according to claim 1, further comprising a voice guidance section which provides voice guidance on information about the device including the type of the device or guidance on remote operation of the device.

10. The remote control apparatus according to claim 2, further comprising a voice guidance section which provides voice guidance on information about the device including the type of the device or guidance on remote operation of the device.

11. The remote control apparatus according to claim 3, further comprising a voice guidance section which provides voice guidance on information about the device including the type of the device or guidance on remote operation of the device.

12. The remote control apparatus according to claim 4, further comprising a voice guidance section which provides voice guidance on information about the device including the type of the device or guidance on remote operation of the device.

13. The remote control apparatus according to claim 5, further comprising a voice guidance section which provides voice guidance on information about the device including the type of the device or guidance on remote operation of the device.

14. The remote control apparatus according to claim 6, further comprising a voice guidance section which provides voice guidance on information about the device including the type of the device or guidance on remote operation of the device.

15. The remote control apparatus according to claim 7, further comprising a voice guidance section which provides voice guidance on information about the device including the type of the device or guidance on remote operation of the device.

16. The remote control apparatus according to claim 8, further comprising a voice guidance section which provides voice guidance on information about the device including the type of the device or guidance on remote operation of the device.

17. The remote control apparatus according to claim 1, wherein the instruction acceptance section accepts instruction by recognizing the user's speech.

18. The remote control apparatus according to claim 2, wherein the instruction acceptance section accepts instruction by recognizing the user's speech.

19. The remote control apparatus according to claim 3, wherein the instruction acceptance section accepts instruction by recognizing the user's speech.

20. The remote control apparatus according to claim 4, wherein the instruction acceptance section accepts instruction by recognizing the user's speech.

21. The remote control apparatus according to claim 5, wherein the instruction acceptance section accepts instruction by recognizing the user's speech.

22. The remote control apparatus according to claim 6, wherein the instruction acceptance section accepts instruction by recognizing the user's speech.

23. The remote control apparatus according to claim 7, wherein the instruction acceptance section accepts instruction by recognizing the user's speech.

24. The remote control apparatus according to claim 8, wherein the instruction acceptance section accepts instruction by recognizing the user's speech.

25. The remote control apparatus according to claim 9, wherein the instruction acceptance section accepts instruction by recognizing the user's speech.

26. The remote control apparatus according to claim 10, wherein the instruction acceptance section accepts instruction by recognizing the user's speech.

27. The remote control apparatus according to claim 11, wherein the instruction acceptance section accepts instruction by recognizing the user's speech.

28. The remote control apparatus according to claim 12, wherein the instruction acceptance section accepts instruction by recognizing the user's speech.

29. The remote control apparatus according to claim 13, wherein the instruction acceptance section accepts instruction by recognizing the user's speech.

30. The remote control apparatus according to claim 14, wherein the instruction acceptance section accepts instruction by recognizing the user's speech.

31. The remote control apparatus according to claim 15, wherein the instruction acceptance section accepts instruction by recognizing the user's speech.

32. The remote control apparatus according to claim 16, wherein the instruction acceptance section accepts instruction by recognizing the user's speech.

33. A remote control method, comprising the steps of:
acquiring, by an image pickup element, an image of a device as a subject which is to be remotely controlled and information specific to the device which is optically transmitted from the device;
storing the acquired image of the device and the information specific to the device being associated with each other in a non-volatile storage medium;
displaying an image stored in the storage medium;
accepting from a user instruction of selection of a desired device to be remotely controlled from among devices whose specific information is stored in the storage medium being associated with the image and selection of desired control to the selected device; and
transmitting a remote control signal corresponding to the selected control for the selected device to the selected device.

34. A remote control program for causing a computer to execute the steps of:
acquiring, by an image pickup element, an image of a device as a subject which is to be remotely controlled and information specific to the device which is optically transmitted from the device;
storing the acquired image of the device and the information specific to the device being associated with each other in a non-volatile storage medium;
displaying an image stored in the storage medium;
accepting from a user instructions of selection of a desired device to be remotely controlled from among devices whose specific information is stored in the storage medium being associated with the image and selection of desired control to the selected device; and
transmitting a remote control signal corresponding to the selected control for the selected device to the selected device.

35. A remote control system, comprising:
a device which optically transmits specific information;
an acquisition section which acquires, by an image pickup element, an image of a device as a subject which is to be remotely controlled and information specific to the device which is optically transmitted from the device;
a storage section which is a non-volatile storage medium for storing the image of the device and the information specific to the device acquired by the acquisition section being associated with each other;
a display section which displays an image stored in the storage section;
an instruction acceptance section which accepts, from a user, instruction of selection of a desired device to be remotely controlled from among devices whose specific information is stored in the storage section being associated with the image and instruction of desired control to the selected device;
a communication section which transmits a remote control signal at least to the device; and
a remote controlling section which controls the communication section to transmit a remote control signal corresponding to the control for the device which has been selected via the instruction acceptance section to the device which has been selected via the designation accepting section,
wherein the device receives the remote control signal transmitted by the communication section and operates in accordance with control corresponding to the remote control signal received.
